(19) United States
(12) Patent Application Publication
(10) Pub. No.: US 2025/0219929 A1
(43) Pub. Date: Jul. 3, 2025

(54) EFFICIENT MULTICAST TRAFFIC DISTRIBUTION IN AN OVERLAY NETWORK USING UNDERLAY MULTICAST DISTRIBUTION

(71) Applicant: HEWLETT PACKARD ENTERPRISE DEVELOPMENT LP, Spring, TX (US)

(72) Inventors: Tathagata Nandy, Bangalore (IN); Chethan Chavadibagilu Radhakrishnabhat, Bangalore (IN); Thomas Samuel, Bangalore (IN); Subramanian Muthukumar, Bangalore (IN); Somnath Bhimaram Lohar, Bangalore (IN)

(21) Appl. No.: 18/608,208

(22) Filed: Mar. 18, 2024

(30) Foreign Application Priority Data
Dec. 28, 2023 (IN) 202341089495

(51) Int. Cl. H04L 45/16; H04L 45/64; H04L 45/76

(52) U.S. Cl. CPC H04L 45/16; H04L 45/64; H04L 45/76; H04L 2212/00

(57) ABSTRACT

A network device operating as a tunnel endpoint in an overlay network is provided. During operation, the network device can receive a multicast packet destined to a first multicast group via an edge port. The edge port can be coupled to the source of the first multicast group. The network device can then map the first multicast group to a second multicast group configured in an underlying network of the overlay network by applying a mapping rule. Subsequently, the network device can encapsulate the multicast packet with a first encapsulation header with a destination address, which is a multicast address of the second multicast group. The network device can then identify a Rendezvous Point (RP) of the second multicast group and forward the encapsulated multicast packet to the RP based on the multicast address of the second multicast group.

### BACKGROUND

A network device, such as a switch, in a network may support different protocols and services. For example, the network device can support an overlay network formed based on tunneling and virtual private networks (VPNs). The network device can then facilitate overlay routing for a VPN over the tunnels.

### BRIEF DESCRIPTION OF THE FIGURES

FIG. 1A illustrates an example of an overlay network supporting efficient multicast traffic distribution based on underlay multicast distribution, in accordance with an aspect of the present application.

FIG. 1B illustrates an example of a packet format supporting efficient multicast traffic distribution based on underlay multicast distribution, in accordance with an aspect of the present application.

FIG. 2 illustrates an example of a mapping rule selecting a multicast group for underlay multicast distribution, in accordance with an aspect of the present application.

FIG. 3 illustrates an example of an overlay network supporting efficient multicast traffic distribution to a querier based on underlay multicast distribution, in accordance with an aspect of the present application.

FIG. 4A presents a flowchart illustrating the process of a network device efficiently distributing multicast traffic based on underlay multicast distribution, in accordance with an aspect of the present application.

FIG. 4B presents a flowchart illustrating the process of a network device applying a mapping to select a multicast group for underlay multicast distribution, in accordance with an aspect of the present application.

FIG. 4C presents a flowchart illustrating the process of a network device efficiently distributing multicast traffic to a querier in a virtual local area network (VLAN) based on underlay multicast distribution, in accordance with an aspect of the present application.

FIG. 5 presents a flowchart illustrating the process of a network device efficiently obtaining multicast traffic based on underlay multicast distribution, in accordance with an aspect of the present application.

FIG. 6 illustrates an example of a network device supporting efficient multicast traffic distribution in an overlay network based on underlay multicast distribution, in accordance with an aspect of the present application.

In the figures, like reference numerals refer to the same figure elements.

### DETAILED DESCRIPTION

In various Internet applications, multicast is frequently used to distribute content such as video from a source to multiple hosts via one or more network devices, such as switches. Efficient distribution of multicast traffic can improve the performance of a network. A network-layer multicast protocol, such as protocol-independent multicast (PIM), can be used for distributing content in a heterogeneous network. In some scenarios, a host can send a client join request (e.g., an Internet Group Management Protocol (IGMP) join request or a Multicast Listener Discovery (MLD) join request) to an upstream switch. The switch can be in an overlay network formed based on overlay routing for a VPN over a set of tunnels. For example, an Ethernet VPN (EVPN) can be deployed as an overlay over a set of virtual extensible local area networks (VXLANs).

To deploy a VPN over the tunnels, a respective tunnel endpoint may map a respective client VLAN to a corresponding tunnel network identifier (TNI), which can identify a virtual network for a tunnel. The TNI may appear in a tunnel header that encapsulates a packet and is used for forwarding the encapsulated packet via a tunnel. For example, if the tunnel is formed based on VXLAN, the TNI can be a virtual network identifier (VNI) of a VXLAN header, and a tunnel endpoint can be a VXLAN tunnel endpoint (VTEP). A TNI can also be mapped to the virtual routing and forwarding (VRF) associated with the tunnels if layer-3 routing and forwarding are needed.

A VPN can be distributed across an overlay network. An overlay network with a VPN can also be referred to as a distributed tunnel fabric. Since the fabric is an overlay network, a respective switch in the fabric can be a tunnel endpoint of one or more tunnels. The fabric can include a gateway device that can facilitate external communication for the fabric. As a result, any other switch of the fabric can communicate with a switch outside the fabric via the gateway device, thereby facilitating communication between networks.

The aspects described herein address the problem of efficiently distributing multicast traffic in an overlay network by (i) mapping a respective multicast group to an underlay multicast group in the underlying (or underlay) network of the overlay network; and (ii) distributing the traffic belonging to the multicast group via a Rendezvous Point (RP) of the underlay multicast group.

Typically, when multicast traffic is distributed from a source of the overlay multicast group, the network device coupling the source can be responsible for distributing the multicast traffic. Accordingly, the network device can replicate the multicast traffic and distribute it via individual tunnels to requesting network devices. Therefore, the multicast traffic can be distributed over tunnels in the overlay network. In contrast, the underlay multicast group can be a bidirectional multicast protocol, such as Bidirectional Protocol Independent Multicast (PIM) or BIDIR-PIM. The multicast traffic of the bidirectional multicast protocol can be distributed from the RP in the underlay network. Hence, the network device can send the multicast traffic to the RP, which can then distribute the multicast traffic to the requesting network devices. As a result, instead of replicating for requesting network devices, the network device can send a multicast traffic flow to the RP and ensure efficient distribution of multicast traffic.

An overlay network, such as a distributed tunnel fabric (i.e., an overlay network with a VPN), can be formed when multiple network devices are coupled to each other via corresponding tunnels. In other words, a respective pair of network devices in the overlay network can be coupled to each other via a tunnel. Therefore, a respective network device in the overlay network can be a tunnel endpoint. In the underlying (or underlay) network of the overlay network, a respective network device can establish a route to every other network device. The network device can use a routing protocol, such as the Border Gateway Protocol (BGP), to establish the route. When a packet is forwarded via a tunnel, the packet is encapsulated with a tunnel header and forwarded via the corresponding route in the underlay network.

With existing technologies, a network device coupling a source of a multicast group can receive multicast traffic of the multicast group. Such a network device can be referred to as a source network device. The source network device can then determine which other network devices have requested data from the multicast group. The source network device can then replicate the multicast traffic and forward the replicated multicast traffic via a corresponding tunnel to each of the requesting network devices. As a result, the replicated multicast traffic can occupy bandwidth and resources on each such tunnel. As a result, multicast replication in an overlay network can become bandwidth-intensive and inefficient.

To address this issue, the distribution of the multicast traffic of the multicast group can be offloaded to a root-path multicast tree (RPMT) in the underlay network. To facilitate the offloading, the multicast group can be mapped to another multicast group that can distribute multicast traffic using the RPMT in the underlay network. Since the other multicast group can be deployed in the underlay network, it can be referred to as an underlay multicast group. The underlay multicast group can operate based on a bidirectional multicast protocol, such as a Bi-directional Protocol Independent Multicast (PIM) or PIM-BIDIR protocol. A respective network device of the overlay network can maintain a set of multicast groups associated with the bidirectional multicast protocol. The set of multicast groups can be identified by corresponding multicast addresses (e.g., a range of multicast Internet Protocol (IP) addresses).

If the network is a spine and leaf network, a set of leaf devices can be coupled to another set of spine devices in a tree topology. The spine devices typically facilitate communication among the leaf devices. The leaf devices can be coupled to end devices and receive traffic from them. The spine devices can then operate as aggregation devices that can aggregate traffic from one or more leaf devices. In addition to operating as an aggregation device, a spine device may couple end devices as well. In an overlay network, the leaf devices can be the overlay network devices (i.e., tunnel endpoints). The spine devices can be the underlay devices participating in the routing protocol of the underlay network (e.g., using respective BGP instances). The leaf devices can also be in the underlay network and participate in the routing protocol of the underlay network. Because both spine and leaf devices can participate in the routing protocol, the forwarding paths of the tunnels of the overlay network can span both spine and leaf devices in the underlay network. Therefore, the spine devices can be the underlay network devices via which the tunnels are established. For example, when a leaf device receives a packet from an end device, the leaf device can encapsulate the packet with a tunnel encapsulation header and forward the encapsulated packet via a corresponding tunnel in the overlay network. The leaf device can forward the encapsulated packet to a spine device via a corresponding path in the underlay network. The spine device can then forward the encapsulated packet toward the destination (i.e., the other endpoint of the tunnel) based on the encapsulation header (e.g., an outer IP address of the encapsulation header). Since the traffic of the overlay network can be distributed via the spine devices, a subset of the spine devices can be preconfigured as the RPs for the bidirectional multicast protocol. A respective multicast group, which can be a PIM sparse-mode or PIM-SM group, of the overlay network can be mapped to a corresponding underlay multicast group selected from the set of multicast groups.

When a source network device receives a multicast packet of an overlay multicast group from the source, the source network device can forward the multicast packet via the RPMT of the corresponding underlay multicast group. Similarly, when a network device receives a client join request (e.g., an IGMP or MLD join) for the overlay multicast group from a requesting host, the network device can send a corresponding network join request (e.g., a PIM join) to the RP of the underlay multicast group. The network devices sending the network join requests can be referred to as the requesting network devices. Based on the network join requests, the requesting network devices can join the RPMT. The multicast traffic can then be distributed via the RPMT.

In this way, the bidirectional multicast protocol can facilitate source-independent multicast traffic distribution. In particular, instead of replicating the multicast traffic for individual tunnels, the source network device can forward the multicast traffic to the RP via the RPMT. The RP can then forward the multicast traffic to a respective requesting network device. Here, the bidirectional multicast protocol can facilitate the distribution of multicast traffic without relying on source-specific multicast trees (SPMTs). Since a network device does not need to maintain the states associated with individual sources, the bidirectional multicast protocol can reduce the multicast processing overhead associated with maintaining the states.

To forward the multicast packet, the source network device can encapsulate the multicast packet with a tunnel encapsulation header and include the multicast address of the underlay multicast group in the encapsulation header. The network device can then forward the encapsulated packet to the RP via the RPMT. The RP can then forward the encapsulated packet to a respective requesting network device via the RPMT. Upon receiving the encapsulated packet, the requesting network device can decapsulate the encapsulation header and forward the multicast packet to the locally coupled requesting hosts. Because the multicast traffic is distributed from the aggregation (or spine) network devices in the underlay network, the distribution of multicast traffic can be efficient and less bandwidth intensive.

Furthermore, the overlay network can facilitate layer-2 extension via corresponding tunnels where a layer-2 broadcast domain (e.g., a VLAN) is distributed across a plurality of tunnel endpoints. Hence, the overlay network can deploy a querier that can snoop multicast control traffic to determine membership of different multicast groups from the requesting hosts in the extended network. One of the network devices in the overlay network can be configured as the querier. Because the querier can be deployed for a VLAN, multicast traffic can typically be flooded via all tunnels and ports associated with the VLAN in the overlay network. To ensure efficient forwarding of the multicast traffic to the querier, another underlay multicast group can be allocated for layer-2 multicast forwarding. The querier can send a network join request to the RP of the underlay multicast group to join the RPMT of the underlay multicast group. A respective source network device can forward a copy of the multicast traffic to the RP via the RPMT on a respective VLAN. As a result, the multicast traffic can be carried via the RPMT to the multicast querier on a respective VLAN. In this way, instead of flooding all tunnels and ports of the VLAN, the source network device can forward the multicast traffic to the RP of the underlay multicast group.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

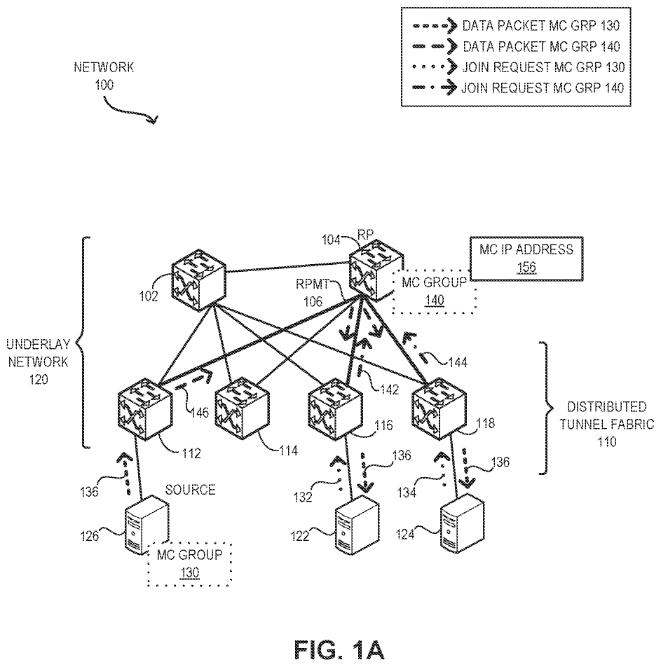

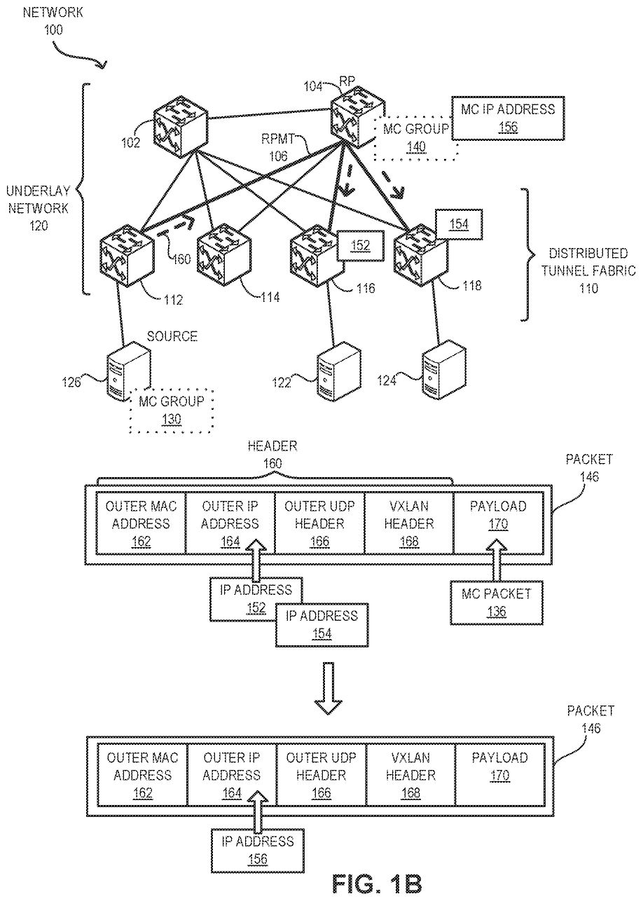

FIG. 1A illustrates an example of an overlay network supporting efficient multicast traffic distribution based on underlay multicast distribution, in accordance with an aspect of the present application. A network 100 can include a number of network devices (e.g., switches), and may include heterogeneous network components, such as layer-2 and layer-3 hops, and tunnels. In some examples, network 100 can be an Ethernet network, InfiniBand network, or other network, and may use a corresponding communication protocol, such as Internet Protocol (IP), FibreChannel over Ethernet (FCOE), or other protocol. Network 100 can include a number of network devices 102, 104, 112, 114, 116, and 118. A respective network device in network 100 can be associated with a MAC address and an IP address. End devices 122, 124, and 126 (e.g., client devices or servers) can be coupled to network devices 116, 118, and 112, respectively.

Network devices 112, 114, 116, and 118 can operate as tunnel endpoints in an overlay network 110, such as a distributed tunnel fabric 110, where the network devices can be coupled to each other via tunnels. Therefore, network devices 112, 114, 116, and 118 can be in fabric 110. For these network devices, tunnel encapsulation is initiated and terminated within fabric 110. Network devices in fabric 110 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). A VPN, such as an EVPN, can be deployed over fabric 110. The tunnels in fabric 110 can be formed over an underlay network 120. Underlay network 120 can be a physical network, and a respective link of the underlying network can be a physical link.

A respective network device in fabric 110 can also be in underlay network 120. Here, a network device operating as a tunnel endpoint can also be in fabric 110. A respective pair of network devices in underlay network 120 can be a BGP peer. Therefore, in underlay network 120, a respective network device can use BGP to establish routes via which packets are forwarded. Accordingly, the encapsulated packets of fabric 110 can be forwarded via these routes in underlay network 120. In some examples, network 100 can be a spine and leaf network wherein network devices 112, 114, 116, and 118 can be leaf devices, and network devices 102 and 104 can be spine devices. Here, leaf devices 112, 114, 116, and 118 can be in fabric 110 as tunnel endpoints. These leaf devices can also be in underlay network 120 where they participate in the BGP routing of underlay network 120. On the other hand, spine devices 102 and 104 can be in underlay network 120 via which the tunnels of fabric 110 are established. Here, spine devices 102 and 104 can forward encapsulated packets of fabric 110 via underlay network 120 based on the corresponding tunnel headers. Under such a network topology, spine devices 102 and 104 can operate as aggregation devices that can aggregate traffic from leaf devices 112, 114, 116, and 118.

In this example, end device 126 can be the source for multicast group 130, which can be a PIM-SM group. End devices 122 and 124 can be the hosts requesting multicast traffic of multicast group 130. Therefore, end device 126 can also be referred to as source 126, and end devices 122 and 124 can also be referred to as requesting hosts 122 and 124. With existing technologies, to send a multicast data packet 136 of multicast group 130 from source 126, network device 112 can replicate packet 136 and distribute packet 136 via individual tunnels to network devices 116 and 118, respectively. In other words, network device 112 can replicate multicast packet 136 and forward replicated packet 136 via a corresponding tunnel to each of network devices 122 and 124. As a result, replicated packet 136 can occupy bandwidth and resources on each such tunnel. As a result, multicast replication in fabric 110 can become bandwidth-intensive and inefficient.

To address this issue, the distribution of the multicast traffic of multicast group 130 can be offloaded to an RPMT 106 in underlay network 120 (denoted with weighted lines). To facilitate the offloading, multicast group 130 can be mapped to underlay multicast group 140. Here, multicast group 140 can operate based on a bidirectional multicast protocol, such as PIM-BIDIR protocol, that can distribute multicast traffic using RPMT 106 in underlay network 120. A respective network device in fabric 110 can maintain a set of multicast groups, which includes multicast group 140, associated with the bidirectional multicast protocol. The set of multicast groups can be identified by a range of multicast IP addresses. The spine devices in network 100 can be preconfigured as RPs for the bidirectional multicast protocol. For example, network device 104 can be the RP of multicast group 140. Hence, RPMT 106 can be rooted at network device 104.

When network device 112 receives packet 136 of multicast group 130 from source 126, network device 112 can apply a mapping rule to multicast group 130 to select multicast group 140 from a range of predetermined multicast groups configured in underlay network 120. The RPs of the range of multicast groups can be distributed on network devices 102 and 104. For example, if there are eight multicast groups configured in underlay network 120, each of network devices 102 and 104 can operate as RPs of four multicast groups. The range of multicast groups can be represented by a corresponding range of multicast addresses. The mapping rule can be based on one or more of: a hash function producing an index for the range of multicast groups, a sequential mapping to the range of multicast groups, and a random mapping to the range of multicast groups.

For example, network device 112 can apply the hash function to the multicast address of multicast group 130 to determine a hash value. The hash value can be an index to the range of multicast addresses preconfigured in underlay network 120. Based on the index, network device 112 can determine multicast address 156, which can be a multicast IP address, of multicast group 140. Network device 112 can then encapsulate multicast packet 136 with an encapsulation header with multicast address 156 as a destination address to generate multicast data packet 146 of multicast group 140. Here, packet 146 can be the encapsulated packet 136. Network device 112 can then forward multicast packet 146 via RPMT 106.

Similarly, network devices 116 and 118 can receive join requests 132 and 134 (e.g., IGMP or MLD joins) for multicast group 130 from hosts 122 and 124, respectively. Network devices 116 and 118 can apply the mapping rule on multicast group 130 to determine multicast group 140. A respective network device in fabric 110 can use the same mapping rule. As a result, network devices 112, 116, and 118 can map multicast group 130 to the same multicast group 140. Network devices 116 and 118 can then send the corresponding network join requests 142 and 144 (e.g., PIM joins), respectively, to RP 104. Based on join requests 142 and 144, network devices 116 and 118, respectively, can join RPMT 106. When network device 112 forwards multicast packet 146 to RP 104 via RPMT 106, RP 104 can forward multicast packet 146 to network devices 116 and 118 via RPMT 106. Upon receiving multicast packet 146, network devices 116 and 118 can decapsulate the encapsulation header and forward multicast packet 136 to hosts 122 and 124, respectively. As a result, hosts 122 and 124 as well as source 126 can remain agnostic to the use of RPMT 106 to distribute multicast packet 136. Because multicast packet 136 is distributed via RPMT 106 while avoiding replication, the distribution can be efficient and less bandwidth intensive.

FIG. 1B illustrates an example of a packet format supporting efficient multicast traffic distribution based on underlay multicast distribution, in accordance with an aspect of the present application. Network devices 116 and 118 can be associated with IP addresses 152 and 154, respectively. Therefore, IP addresses 152 and 154 can be used to forward traffic to network devices 116 and 118, respectively, in underlay network 120. Without using RPMT 106, network device 112 can replicate encapsulated multicast packet 146 for both IP addresses 152 and 154. On the other hand, if network device 112 uses RPMT 106, network device 112 can forward packet 146 to IP address 156 of multicast group 140.

Packet 146 can be generated by encapsulating multicast packet 136 with a tunnel encapsulation header 160. Therefore, payload 170 of packet 146 can include packet 136. If the tunnels in fabric 110 are formed based on VXLAN, header 160 can include an outer User Datagram Protocol (UDP) header 166 and a VXLAN header 168. VXLAN header 168 can include a VNI corresponding to the VLAN of packet 136. Furthermore, outer UDP header 166 can include a default UDP port number. To forward packet in underlay network 120, header 160 can include an outer MAC address 162 and an outer IP address 164. If network device 112 replicates packet 146 in fabric 110, outer IP address 164 can be IP addresses 152 and 154 for network devices 116 and 118, respectively.

In contrast, if network device 112 uses RPMT 106, outer IP address 164 can be IP address 156. Packet 146 can then be forwarded to RP 104, which in turn, can forward packet 146 to network devices 116 and 118 via RPMT 106. In this way, the bidirectional multicast protocol can facilitate source-independent multicast traffic distribution in network 100. In particular, instead of replicating the multicast traffic for individual tunnels, network device 112 can forward the multicast traffic to RP 104 via RPMT 106 without relying on SPMTs. Since network device 112 does not need to maintain the states associated with source 126, the bidirectional multicast protocol can reduce the multicast processing overhead associated with maintaining the states.

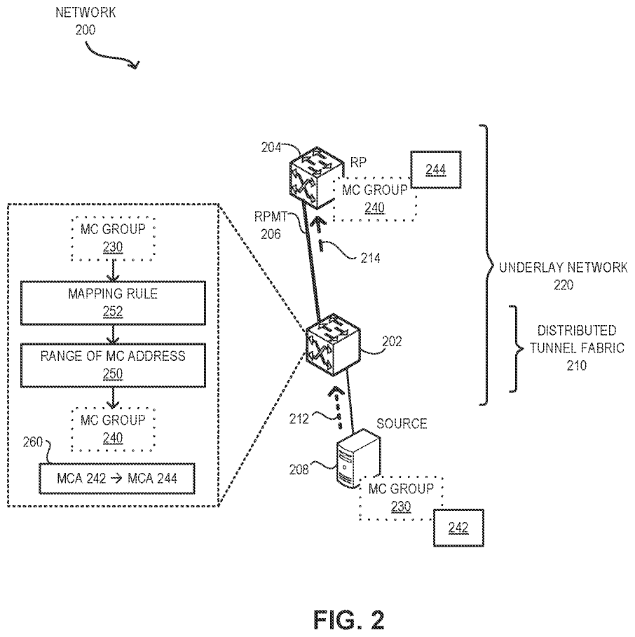

FIG. 2 illustrates an example of a mapping rule selecting a multicast group for underlay multicast distribution, in accordance with an aspect of the present application. A network 200 can include a number of network devices (e.g., switches), and may include heterogeneous network components, such as layer-2 and layer-3 hops, and tunnels. In some examples, network 200 can be an Ethernet network, InfiniBand network, or other network, and may use a corresponding communication protocol, such as IP, FCOE, or other protocol. Network 200 can include a number of network devices 202 and 204. A respective network device in network 200 can be associated with a MAC address and an IP address. An end device 208 can be coupled to network device 202.

Network device 202 can operate as a tunnel endpoint in an overlay network 210, such as a distributed tunnel fabric 210, where the network devices can be coupled to each other via tunnels. Fabric 210 can include other switches not shown in FIG. 2. Therefore, network device 202 can be in fabric 210. For network device 202, tunnel encapsulation is initiated and terminated within fabric 210. Examples of a tunnel can include, but are not limited to, VXLAN, GRE, NVGRE, Geneve, IPsec, and MPLS. A VPN, such as an EVPN, can be deployed over fabric 210. The tunnels in fabric 210 can be formed over an underlay network 220, which can include network devices 202 and 204. Underlay network 220 can be a physical network, and a respective link of the underlying network can be a physical link. A respective pair of network devices in underlay network 220 can be a BGP peer. Therefore, in underlay network 220, a respective network device can use BGP to establish routes via which packets are forwarded. Accordingly, the encapsulated packets of fabric 210 can be forwarded via these routes in underlay network 220.

End device 208 can be a source of multicast group 230. During operation, source 208 can send a multicast packet 212 belonging to multicast group 230. To efficiently distribute multicast packet 212, network device 202 can use an RPMT 206 in underlay network 220 (denoted with weighted lines). Network device 202 can map multicast group 230 to underlay multicast group 240. Multicast group 240 can operate based on a bidirectional multicast protocol that can distribute multicast traffic using RPMT 206 in underlay network 220. Network device 204 can be the RP of multicast group 240. Hence, RPMT 206 can be rooted at network device 204. End device 202 can maintain a set of multicast groups, which includes multicast group 240, associated with the bidirectional multicast protocol. The set of multicast groups can be identified by a range of multicast IP addresses 250.

When network device 202 receives packet 212 of multicast group 230 from source 208, network device 202 can apply a mapping rule 252 to multicast group 230 to select multicast group 240 from a range of predetermined multicast groups configured in underlay network 220. The range of multicast groups can be represented by corresponding range of multicast addresses 250. The mapping rule can be based on one or more of: a hash function producing an index for the range of multicast groups, a sequential mapping to the range of multicast groups, and a random mapping to the range of multicast groups.

For example, network device 112 can apply the hash function to multicast address 242 of multicast group 130 to determine a hash value. The hash value can be an index to range of multicast addresses 250. Based on the index, network device 202 can determine multicast address 244 in range of multicast addresses 250. If the index is i, multicast address 244 can be the ith address in range of multicast addresses 250. Here, multicast addresses 242 and 244 can be multicast IP addresses of multicast groups 230 and 240, respectively. Network device 202 can then generate a mapping 260 between multicast addresses 242 and 244, and store the mapping in a storage medium of network device 202. Here, mapping 260 can represent a mapping between multicast groups 230 and 240. Network device 202 can encapsulate multicast packet 212 with an encapsulation header with multicast address 244 as a destination address to generate multicast packet 214 of multicast group 240. Packet 214 can be the encapsulated multicast packet 212. Subsequently, network device 202 can forward multicast packet 214 via RPMT 206.

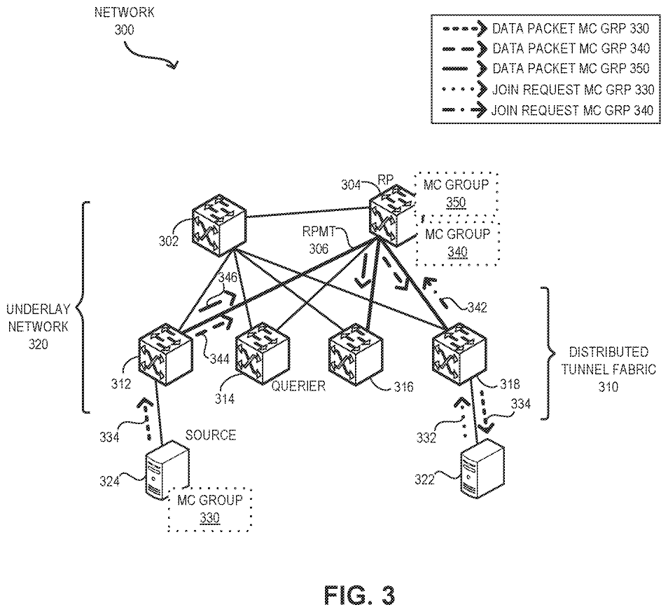

FIG. 3 illustrates an example of an overlay network supporting efficient multicast traffic distribution to a querier based on underlay multicast distribution, in accordance with an aspect of the present application. A network 300 can include a number of network devices (e.g., switches), and may include heterogeneous network components, such as layer-2 and layer-3 hops, and tunnels. In some examples, network 300 can be an Ethernet network, InfiniBand network, or other network, and may use a corresponding communication protocol, such as IP, FCOE, or other protocol. Network 300 can include a number of network devices 302, 304, 312, 314, 316, and 318. A respective network device in network 300 can be associated with a MAC address and an IP address. End devices 322 and 324 can be coupled to network devices 318 and 312, respectively.

Network devices 312, 314, 316, and 318 can operate as tunnel endpoints in an overlay network 310, such as a distributed tunnel fabric 310, where the network devices can be coupled to each other via tunnels. Therefore, network devices 312, 314, 316, and 318 can be in fabric 310. For these network devices, tunnel encapsulation is initiated and terminated within fabric 310. Examples of a tunnel can include, but are not limited to, VXLAN, GRE, NVGRE, Geneve, IPsec, and MPLS. A VPN, such as an EVPN, can be deployed over fabric 310. The tunnels in fabric 310 can be formed over an underlay network 320, which can include network devices 302, 304, 312, 314, 316, and 318. Underlay network 320 can be a physical network, and a respective link of the underlying network can be a physical link. A respective pair of network devices in underlay network 320 can be a BGP peer. Therefore, in underlay network 320, a respective network device can use BGP to establish routes via which packets are forwarded. Accordingly, the encapsulated packets of fabric 310 can be forwarded via these routes in underlay network 320.

End device 324 can be a source of multicast group 330. During operation, source 324 can send a multicast packet 334 belonging to multicast group 330. To efficiently distribute multicast packet 334, network device 312 can use an RPMT 306 in underlay network 320 (denoted with weighted lines). Network device 312 can map multicast group 330 to underlay multicast group 340. Here, multicast group 340 can operate based on a bidirectional multicast protocol that can distribute multicast traffic using RPMT 306 in underlay network 320. Network device 304 can be the RP of multicast group 340. Hence, RPMT 306 can be rooted at network device 304. Network device 312 can encapsulate multicast packet 334 with an encapsulation header with a multicast address of multicast group 340 as a destination address to generate multicast packet 344 of multicast group 340. Packet 344 can be the encapsulated multicast packet 334. Subsequently, network device 312 can forward multicast packet 344 via RPMT 306.

On the other hand, network device 318 can receive join request 332 (e.g., IGMP or MLD join) for multicast group 330 from host 322. Network device 318 can apply the mapping rule on multicast group 330 to determine multicast group 340. A respective network device in fabric 310 can use the same mapping rule. As a result, network devices 312 and 318 can map multicast group 330 to the same multicast group 340. Network device 318 can then send the corresponding network join request 342 (e.g., PIM join) to RP 304. Based on join request 342, network device 318 can join RPMT 306. Upon receiving multicast packet 344, RP 304 can forward multicast packet 344 to network device 318 via RPMT 306. Network device 318 can receive multicast packet 344, decapsulate the encapsulation header, and forward multicast packet 334 to host 322.

Since fabric 310 can facilitate layer-2 extension via corresponding tunnels, fabric 310 can deploy a querier. In fabric 310, end device 314 can operate as the querier and hence, can be referred to as querier 314. Querier 314 can receive the multicast traffic of multicast group 330 without receiving a join request from a host coupled to querier 314. Because querier 314 can be deployed for a VLAN, multicast traffic can typically be flooded via all tunnels and ports associated with the VLAN in fabric 310. To ensure efficient forwarding of the multicast traffic to querier 314, another underlay multicast group 350 can be allocated for layer-2 multicast forwarding.

Network device 312 can encapsulate a copy of multicast packet 334 with an encapsulation header with a multicast address of multicast group 350 as a destination address to generate multicast packet 346 of multicast group 350. Network device 312 can then forward multicast packet 346 to RP 304 on a respective VLAN. Querier 314 can send a network join request (e.g., a PIM join request) to RP 304 to join RPMT 306. As a result, the multicast traffic can be forwarded to querier 314 on a respective VLAN. In this way, instead of flooding all tunnels and ports of the VLAN, network device 312 can forward multicast packet 346 to RP 304.

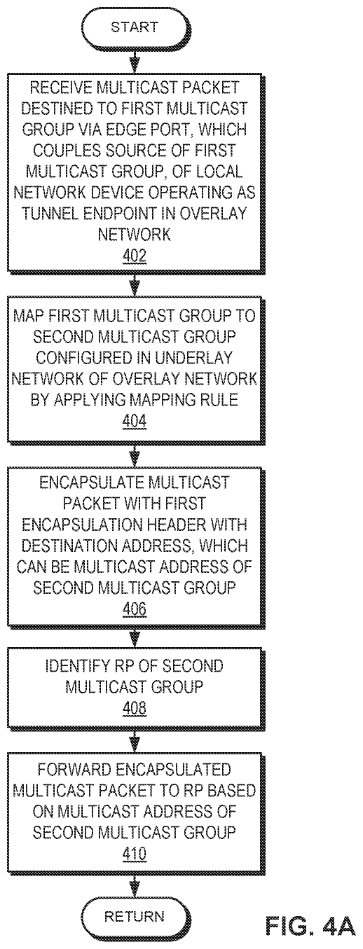

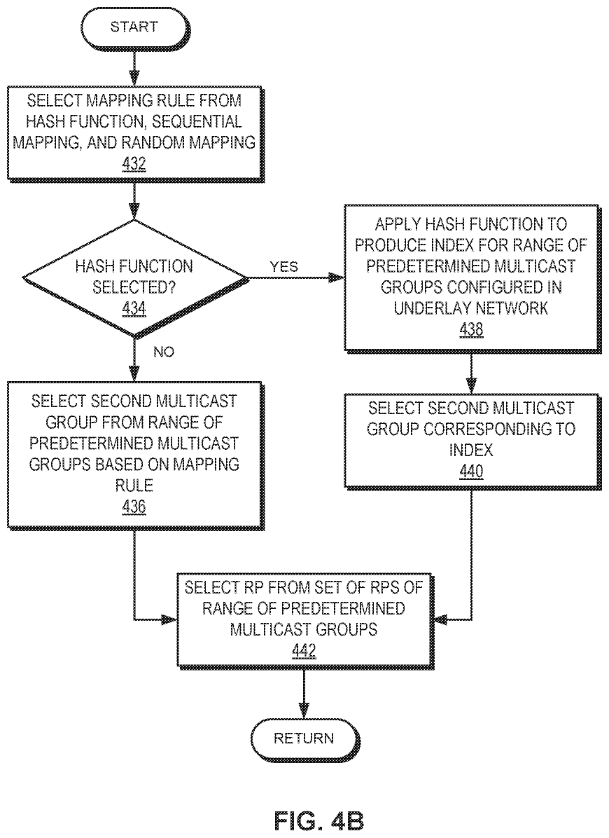

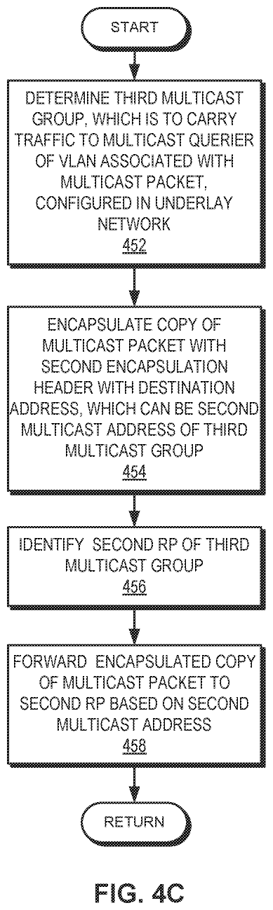

FIG. 4A presents a flowchart illustrating the process of a network device efficiently distributing multicast traffic based on underlay multicast distribution, in accordance with an aspect of the present application. During operation, the network device can receive a multicast packet destined to a first multicast group via an edge port, which couples the source of the first multicast group of the local network device (operation 402). The local network device (i.e., the network device coupling the source) can operate as a tunnel endpoint in an overlay network. The first multicast group can be a PIM-SM multicast group. Because the source of the multicast group is coupled via an edge port of the network device, the network device can be responsible for distributing the multicast traffic of the first multicast group in the overlay network. To efficiently distribute the multicast traffic, the network device can map the first multicast group to a second multicast group configured in the underlay (or underlying) network of the overlay network by applying a mapping rule (operation 404). The second multicast group can be preconfigured in the underlay network. The mapping rule can obtain the first multicast group as an input and indicate the second multicast group as an output.

The network device can then use an RPMT of the second multicast group to distribute the multicast packet. Accordingly, the network device can encapsulate the multicast packet with a first encapsulation header with a destination address, which can be the multicast address of the second multicast group (operation 406). The encapsulation header can be a tunnel header with an outer IP address. The outer IP address can indicate the destination of the encapsulated multicast packet in the underlay network. Hence, the outer IP address can include the multicast address, which can be a multicast IP address, of the second multicast group. Since the RPMT can be rooted at the RP of the second multicast group, the network device can identify the RP of the second multicast group (operation 408). The RP can be preconfigured on a network device of the underlay network. To forward the encapsulated packet via the RPMT, the network device can forward the encapsulated multicast packet to the RP based on the multicast address of the second multicast group (operation 410). The encapsulated multicast packet can then be forwarded to the RP in accordance with the multicast address in the underlay network.

FIG. 4B presents a flowchart illustrating the process of a network device applying a mapping to select a multicast group for underlay multicast distribution, in accordance with an aspect of the present application. The network device can support a plurality of mapping rules, such as hash function, sequential mapping, and random mapping. During operation, the network device can select the mapping rule from the hash function, sequential mapping, and random mapping (operation 432). If the network device supports one of the mapping rules, the supported mapping rule can be preconfigured and hence, preselected, on the network device. If the hash function is selected (operation 434), the network device can apply the hash function to produce an index for the range of predetermined multicast groups configured in the underlay (or underlying) network (operation 438). The hash function can be applied to the multicast address of the first multicast group. The hash function can then generate an index (e.g., a non-negative integer). The network device can then select the second multicast group corresponding to the index from the range of predetermined multicast groups (operation 440). For example, if the index is i, the second multicast group can be the ith multicast group in the range of predetermined multicast groups.

On the other hand, if the hash function is not selected (or preconfigured), the network device can select the second multicast group from the range of predetermined multicast groups based on the mapping rule (operation 436). For example, if the sequential mapping is selected, the second multicast group can be the next available multicast group in the range of predetermined multicast groups. Furthermore, if the random mapping is selected, the second multicast group can be a randomly selected multicast group from the available multicast groups in the range of predetermined multicast groups. Upon selecting the second multicast group (operation 436 or 440), the network device can select the RP from a set of RPs of the range of predetermined multicast groups (operation 442). A subset of the network devices in the underlay network can be preconfigured as respective RPs of the range of predetermined multicast groups. These RPs can be distributed among the subset of the network devices.

FIG. 4C presents a flowchart illustrating the process of a network device efficiently distributing multicast traffic to a querier in a VLAN based on underlay multicast distribution, in accordance with an aspect of the present application. During operation, the network device can determine a third multicast group, which is to carry the traffic to a multicast quarrier of the VLAN associated with the multicast packet, configured in the underlay network (operation 452). The querier can be a network device in the overlay network. The querier can receive traffic of the multicast traffic of a multicast group without receiving a join request from a host. Therefore, the network device can encapsulate a copy of the multicast packet with a second encapsulation header with a destination address, which can be the second multicast address of the third multicast group (operation 454). Here, the outer IP address of the second encapsulation header can include the multicast address of the third multicast group.

The RPMT of the third multicast group can be rooted at an RP of the third multicast group. Hence, the network device can identify a second RP of the third multicast group (operation 456). The RP of the second multicast group and the third multicast group can be preconfigured on the same or on a different network device of the underlay network. To forward the encapsulated packet via the RPMT, the network device can forward the encapsulated multicast packet to the second RP based on the multicast address of the second multicast group (operation 458). The encapsulated copy of the multicast packet can then be forwarded to the second RP in accordance with the second multicast address in the underlay network.

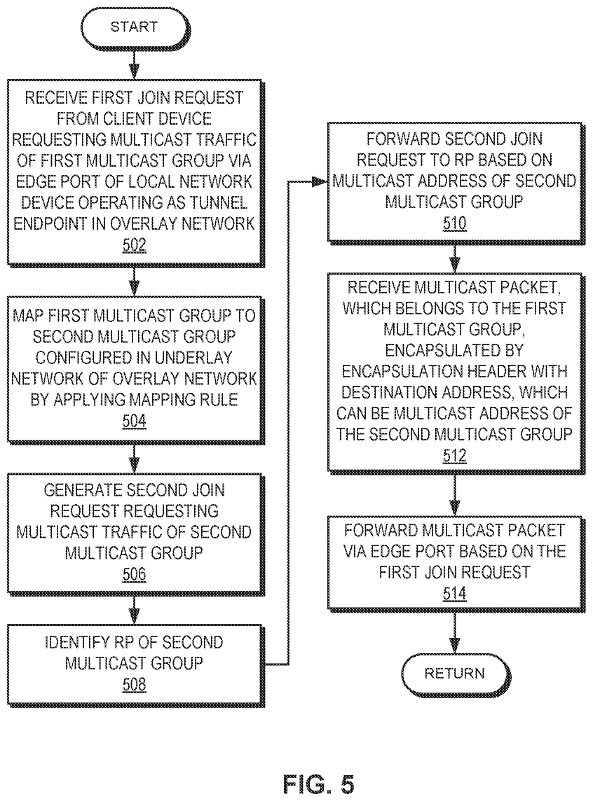

FIG. 5 presents a flowchart illustrating the process of a network device efficiently obtaining multicast traffic based on underlay multicast distribution, in accordance with an aspect of the present application. During operation, the network device can receive a first join request (e.g., an IGMP join request) from a client device requesting multicast traffic from the first multicast group via an edge port of the local network device (operation 502). Therefore, the client device can be a requesting host of the first multicast group. The local network device (i.e., the network device coupling the requesting host) can operate as a tunnel endpoint in an overlay network. Because the client device is coupled via an edge port of the network device, the network device can be responsible for retrieving the multicast traffic of the first multicast group in the overlay network. The network device can identify the outgoing ports for the first multicast group based on the ports via which a corresponding join request is received. Accordingly, the edge port can then be marked as an outgoing port of the first multicast group.

To efficiently obtain the multicast traffic, the network device can map the first multicast group to a second multicast group configured in the underlay (or underlying) network of the overlay network by applying a mapping rule (operation 504). A respective network device in the overlay network can use the same mapping rule. As a result, the source network device and the requesting network device can map the first multicast group to the same second multicast group. The network device can then use an RPMT of the second multicast group to obtain the multicast traffic of the first multicast group. Accordingly, the network device can generate a second join request (e.g., a PIM join request) requesting multicast traffic of the second multicast group (operation 506). The second join request allows the network device to join the RPMT of the second multicast group.

Since the RPMT can be rooted at the RP of the second multicast group, the network device can identify the RP of the second multicast group (operation 508). The RP can be preconfigured on a network device of the underlay network and can be reachable via the multicast address of the second multicast group. Hence, the network device can forward the second join request to the RP based on the multicast address of the second multicast group (operation 510). The second join request can then be forwarded to the RP in accordance with the multicast address in the underlay network. Based on the second join request, the network device can join the RPMT of the second multicast group.

The RPMT of the second multicast group can be used to carry multicast packets of the first multicast group based on the encapsulation headers attached to the multicast packets. Such an encapsulation header can encapsulate a multicast packet of the first multicast group and can include the multicast address of the second multicast group as the outer IP address. As a result, the RP can forward the encapsulated packet via the RPMT to the network device. Consequently, the network device can receive the multicast packet, which belongs to the first multicast group, encapsulated by an encapsulation header with the destination address, which can be the multicast address of the second multicast group (operation 512). Because the network device is on the RPMT, the network device can then decapsulate the encapsulation header to obtain the multicast packet. The network device can then forward the multicast packet via the edge port (e.g., as an outgoing port) based on the first join request (operation 514).

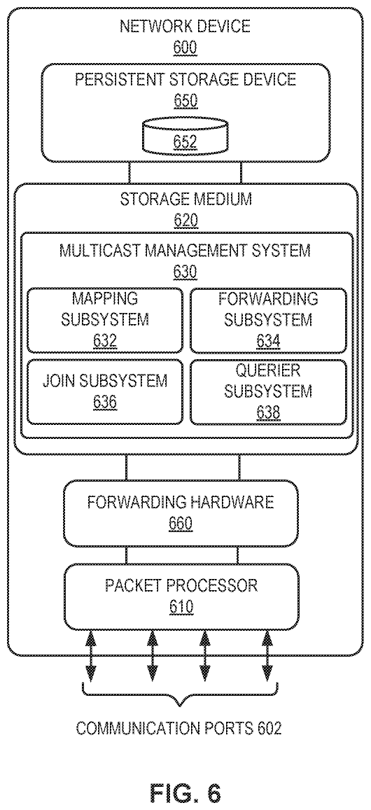

FIG. 6 illustrates an example of a network device supporting efficient multicast traffic distribution in an overlay network based on underlay multicast distribution, in accordance with an aspect of the present application. In this example, a network device 600, which can also be referred to as a switch 600, can include a number of communication ports 602, a packet processor 610, and a persistent storage device 650. Network device 600 can also include forwarding hardware 660 (e.g., processing hardware of network device 600, such as its application-specific integrated circuit (ASIC) chips), which includes information based on which network device 600 processes packets (e.g., determines output ports for packets).

Packet processor 610 can extract and process header information from the received packets. Packet processor 610 can identify a network device identifier (e.g., a MAC address and/or an IP address) associated with network device 600 in the header of a packet. Network device 600 can include a storage medium 620. In some examples, storage medium 620 can include a set of volatile memory devices (e.g., dual in-line memory module (DIMM)). Network device 600 can operate as a tunnel endpoint in an overlay network (e.g., in a fabric).

Communication ports 602 can include inter-device communication channels for communication with other network devices and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port.

Network device 600 can maintain a database 652 (e.g., in storage device 650). Database 652 can be a relational database and may run on one or more Database Management System (DBMS) instances. Database 652 can store information associated with the routing, configuration, and interfaces of network device 600. Database 652 may store the routing data structures populated based on a BGP instance running on network device 600. Storage medium 620 can include instructions associated with a multicast management system 630 that can allow network device 600 to efficiently forward bidirectional multicast traffic.

Multicast management system 630 can include a mapping subsystem 632, a forwarding subsystem 634, a join subsystem 636, and a querier subsystem 638. A respective subsystem can include instructions executable by network device 600 to perform one or more operations. Mapping subsystem 632 can include instructions to apply a mapping rule to a first multicast group to determine a second multicast group configured in the underlay network of the overlay network. Mapping subsystem 632 can also include instructions to identify the RP of the second multicast group.

If a source of the first multicast group is coupled to network device 600, forwarding subsystem 634 can include instructions to send encapsulated multicast traffic of the first multicast group to the RP via the RPMT of the second multicast group. On the other hand, join subsystem 636 can include instructions to send a network join request to the RP for the second multicast group upon receiving a join request from a requesting host for the first multicast group. If network device 600 is configured as a querier in the overlay network, querier subsystem 638 can include instructions to send a network join request to the RP for a third multicast group, which can be configured in the underlay network and dedicated for distributing traffic to the querier.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device operating as a tunnel endpoint in an overlay network. During operation, the network device can receive a multicast packet destined to a first multicast group via an edge port of the network device. Here, the edge port can be coupled to a source of the first multicast group. The network device can then map the first multicast group to a second multicast group configured in an underlying network of the overlay network by applying a mapping rule. Subsequently, the network device can encapsulate the multicast packet with a first encapsulation header with a destination address, which is a multicast address of the second multicast group. The network device can then identify a Rendezvous Point (RP) of the second multicast group and forward the encapsulated multicast packet to the RP based on the multicast address of the second multicast group.

In a variation on this aspect, the mapping rule can include at least one of: a hash function producing an index for a range of predetermined multicast groups configured in the underlying network, a sequential mapping to the range of multicast groups, and a random mapping to the range of multicast groups.

In a variation on this aspect, the first multicast group can be based on a Protocol Independent Multicast (PIM) sparse-mode (SM) protocol. On the other hand, the second multicast group can be based on a bidirectional PIM (PIM-BIDIR) protocol.

In a variation on this aspect, the network device can identify the RP of the second multicast group by selecting the RP from a set of RPs of a range of predetermined multicast groups configured in the underlying network and using the mapping rule to select the second multicast group from the range of predetermined multicast groups.

In a variation on this aspect, the multicast traffic from the source of the first multicast group can be forwarded via a multicast tree rooted at the RP of the second multicast group.

In a variation on this aspect, the network device can determine a third multicast group configured in the underlying network. The third multicast group can be for carrying multicast traffic to a multicast querier of a VLAN associated with the multicast packet.

In a further variation, the network device can encapsulate a copy of the multicast packet with a second encapsulation header. Here, the destination address of the second encapsulation header includes a second multicast address of the third multicast group. The network device can identify a second RP of the third multicast group and forward the encapsulated copy of the multicast packet to the second RP based on the second multicast address.

In a further variation, the third multicast group can be associated with a respective multicast group sending traffic over the VLAN.

Another aspect of the present technology can provide a network device operating as a tunnel endpoint in an overlay network. During operation, the network device can receive a first join request from a client device requesting multicast traffic of a first multicast group via an edge port of the network device. Here, the network device operates as a tunnel endpoint in the overlay network. The network device can then map the first multicast group to a second multicast group configured in an underlying network of the overlay network by applying a mapping rule. Subsequently, the network device can generate a second join request requesting multicast traffic of the second multicast group. The network device can then identify a Rendezvous Point (RP) of the second multicast group and forward the second join request to the RP based on a multicast address of the second multicast group.

In a variation on this aspect, the network device can receive a multicast packet encapsulated by an encapsulation header with a destination address, which is the multicast address of the second multicast group. The multicast packet can belong to the first multicast group. The network device can forward the multicast packet via the edge port based on the first join request.

In a variation on this aspect, the mapping rule can include at least one of: a hash function producing an index for a range of predetermined multicast groups configured in the underlying network, a sequential mapping to the range of multicast groups, and a random mapping to the range of multicast groups.

In a variation on this aspect, the first multicast group can be based on a Protocol Independent Multicast (PIM) sparse-mode (SM) protocol. On the other hand, the second multicast group can be based on a bidirectional PIM (PIM-BIDIR) protocol.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
receiving, by a network device in an overlay network, a multicast packet destined to a first multicast group via an edge port of the network device, wherein the network device operates as a tunnel endpoint in the overlay network, and wherein the edge port is coupled to a source of the first multicast group;
mapping, by the network device, the first multicast group to a second multicast group configured in an underlying network of the overlay network by applying a mapping rule;
encapsulating, by the network device, the multicast packet with a first encapsulation header with a destination address, which is a multicast address of the second multicast group;
identifying, by the network device, a Rendezvous Point (RP) of the second multicast group; and
forwarding, by the network device, the encapsulated multicast packet to the RP based on the multicast address of the second multicast group.

2. The method of claim 1, wherein the mapping rule comprises at least one of:
a hash function producing an index for a range of predetermined multicast groups configured in the underlying network;
a sequential mapping to the range of multicast groups; and
a random mapping to the range of multicast groups.

3. The method of claim 1, wherein the first multicast group is based on a Protocol Independent Multicast (PIM) sparse-mode (SM) protocol, and wherein the second multicast group is based on a bidirectional PIM (PIM-BIDIR) protocol.

4. The method of claim 1, wherein identifying the RP of the second multicast group comprises:
selecting the RP from a set of RPs of a range of predetermined multicast groups configured in the underlying network; and
using the mapping rule to select the second multicast group from the range of predetermined multicast groups.

5. The method of claim 1, wherein multicast traffic from the source of the first multicast group is forwarded via a multicast tree rooted at the RP of the second multicast group.

6. The method of claim 1, further comprising determining, by the network device, a third multicast group configured in the underlying network, wherein the third multicast group is for carrying multicast traffic to a multicast querier of a virtual local area network (VLAN) associated with the multicast packet.

7. The method of claim 6, further comprising:
encapsulating, by the network device, a copy of the multicast packet with a second encapsulation header, wherein a destination address of the second encapsulation header comprises a second multicast address of the third multicast group;
identifying, by the network device, a second RP of the third multicast group; and
forwarding, by the network device, the encapsulated copy of the multicast packet to the second RP based on the second multicast address.

8. The method of claim 1, wherein the third multicast group is associated with a respective multicast group sending traffic over the VLAN.

9. A non-transitory computer-readable storage medium storing instructions that when executed by a processor of a network device in an overlay network cause the processor to perform a method, the method comprising:
receiving a multicast packet destined to a first multicast group via an edge port of the network device, wherein the network device operates as a tunnel endpoint in the overlay network, and wherein the edge port is coupled to a source of the first multicast group;
mapping the first multicast group to a second multicast group configured in an underlying network of the overlay network by applying a mapping rule;
encapsulating, by the network device, the multicast packet with a first encapsulation header with a destination address, which is a multicast address of the second multicast group;
identifying a Rendezvous Point (RP) of the second multicast group; and
forwarding the encapsulated multicast packet to the RP based on the multicast address of the second multicast group.

10. The non-transitory computer-readable storage medium of claim 9, wherein the mapping rule comprises at least one of:
a hash function producing an index for a range of predetermined multicast groups configured in the underlying network;
a sequential mapping to the range of multicast groups; and
a random mapping to the range of multicast groups.

11. The non-transitory computer-readable storage medium of claim 9, wherein the first multicast group is based on a Protocol Independent Multicast (PIM) sparse-mode (SM) protocol, and wherein the second multicast group is based on a bidirectional PIM (PIM-BIDIR) protocol.

12. The non-transitory computer-readable storage medium of claim 9, wherein identifying the RP of the second multicast group comprises:
selecting the RP from a set of RPs of a range of predetermined multicast groups configured in the underlying network; and
using the mapping rule to select the second multicast group from the range of predetermined multicast groups.

13. The non-transitory computer-readable storage medium of claim 9, wherein multicast traffic from the source of the first multicast group is forwarded via a multicast tree rooted at the RP of the second multicast group.

14. The non-transitory computer-readable storage medium of claim 9, wherein the method further comprises determining a third multicast group configured in the underlying network, wherein the third multicast group is for carrying multicast traffic to a multicast querier of a virtual local area network (VLAN) associated with the multicast packet.

15. The non-transitory computer-readable storage medium of claim 14, wherein the method further comprises:
encapsulating a copy of the multicast packet with a second encapsulation header, wherein a destination address of the second encapsulation header comprises a second multicast address of the third multicast group;
identifying a second RP of the third multicast group; and
forwarding the encapsulated copy of the multicast packet to the second RP based on the second multicast address.

16. The non-transitory computer-readable storage medium of claim 14, wherein the third multicast group is associated with a respective multicast group sending traffic over the VLAN.

17. A method comprising:
receiving, by a network device in an overlay network, a first join request from a client device requesting multicast traffic of a first multicast group via an edge port of the network device, wherein the network device operates as a tunnel endpoint in the overlay network;
mapping, by the network device, the first multicast group to a second multicast group configured in an underlying network of the overlay network by applying a mapping rule;
generating, by the network device, a second join request requesting multicast traffic of the second multicast group;
identifying, by the network device, a Rendezvous Point (RP) of the second multicast group; and
forwarding, by the network device, the second join request to the RP based on a multicast address of the second multicast group.

18. The method of claim 17, further comprising:
receiving, by the network device, a multicast packet encapsulated by an encapsulation header with a destination address, which is the multicast address of the second multicast group, wherein the multicast packet belongs to the first multicast group; and
forwarding, by the network device, the multicast packet via the edge port based on the first join request.

19. The method of claim 17, wherein the mapping rule comprises at least one of:
a hash function producing an index for a range of predetermined multicast groups configured in the underlying network;
a sequential mapping to the range of multicast groups; and
a random mapping to the range of multicast groups.

20. The method of claim 17, wherein the first multicast group is based on a Protocol Independent Multicast (PIM) sparse-mode (SM) protocol, and wherein the second multicast group is based on a bidirectional PIM (PIM-BIDIR) protocol.
